(19) United States
(12) Patent Application Publication
(10) Pub. No.: US 2015/0274193 A1
(43) Pub. Date: Oct. 1, 2015

(54) STEERING APPARATUS AND BEARING MEMBER

(71) Applicant: SHOWA CORPORATION, Gyoda-shi (JP)

(72) Inventors: Mitsuo SAITO, Haga-gun (JP); Hitoshi AKAGI, Haga-gun (JP)

(73) Assignee: SHOWA CORPORATION, Gyoda-shi (JP)

(21) Appl. No.: 14/573,877

(22) Filed: Dec. 17, 2014

(30) Foreign Application Priority Data
Mar. 28, 2014 (JP) 2014-069049

(51) Int. Cl. B62D 3/12

(52) U.S. Cl. CPC B62D 3/126

(57) ABSTRACT

A steering apparatus includes a pinion shaft, a rack shaft, a bearing member, an accommodating member and a pressing member. The pinion shaft has a pinion. The rack shaft has a rack which meshes with the pinion of the pinion shaft. The bearing member has a bearing portion which supports the rack shaft in such a manner that the rack shaft is slidable in an axial direction of the rack shaft, and a protruding portion which protrudes from the bearing portion in a radial direction of the rack shaft and the axial direction. The accommodating member accommodates the bearing member. The pressing member is inserted into the accommodating member in the axial direction, and axially presses the protruding portion of the bearing member against the accommodating member.

### CROSS-REFERENCE TO RELATED APPLICATIONS

This application is based on and claims priority under 35 USC §119 from Japanese Patent Application No. 2014-069049 filed on Mar. 28, 2014, the entire content of which is incorporated herein by reference.

### BACKGROUND OF THE INVENTION

1. Technical Field

The present invention relates to a steering apparatus and a bearing member.

2. Related Art

A steering apparatus includes a pinion shaft connected to an input shaft, and a rack shaft that has a rack connected to a pinion of the pinion shaft. The rack shaft is supported by a bearing member such as a bush that is accommodated in an accommodating member such as a rack stopper, in such a manner that the rack shaft is slidable in an axial direction thereof.

In the related art, for example, Patent Literature 1 (JP-A-11-198827) discloses a rack and pinion steering apparatus that includes a synthetic resin-made bush to allow the rack shaft to slide, and the rack stopper to fix the bush. In the steering apparatus, the bush includes a cylindrical bush main body, and an annular protrusion that protrudes radially outwardly from the bush main body. The annular protrusion of the bush is fitted into a concave portion formed in a bush stopper, thereby preventing the bush from slipping out of the bush stopper.

### SUMMARY OF THE INVENTION

When the bearing member is accommodated in the accommodating member, the bearing member may move inside a sliding member in the axial direction, in association with the sliding of the rack shaft.

For example, when the bearing member is made of a resin material, the bearing member may not be sufficiently regulated in the accommodating member due to the thermal expansion of the bearing member in high temperature conditions, or the contraction of the bearing member in low temperature conditions, and thus the bearing member may move in the axial direction in association with the sliding of the rack shaft. When the bearing member moves in the axial direction, the bearing member collides with the accommodating member that accommodates the bearing member, thereby causing noise to occur.

An object of the present invention is to prevent the axial movement of a bearing member with which a rack shaft is supported in a state of being slidable in an axial direction of the rack shaft.

According to an aspect of the present invention, provided is a steering apparatus including a pinion shaft that has a pinion; a rack shaft that has a rack which meshes with the pinion of the pinion shaft; a bearing member that has a bearing portion which supports the rack shaft in such a manner that the rack shaft is slidable in an axial direction of the rack shaft, and a protruding portion which protrudes from the bearing portion in a radial direction of the rack shaft and the axial direction; an accommodating member that accommodates the bearing member; and a pressing member that is inserted into the accommodating member in the axial direction, and axially presses the protruding portion of the bearing member against the accommodating member.

Here, in the steering apparatus, the bearing member may be made of a resin material. The protruding portion may be interposed between the pressing member and the accommodating member in a state that the protruding portion is deformed. With this configuration, for example, it is possible to prevent the axial movement of the bearing member even in low temperature conditions.

In the steering apparatus, an axial length of the protruding portion of the bearing member may increase from a radially inner circumference of the protruding portion to a radially outer circumference thereof. With this configuration, compared to when the above-mentioned configuration is not adopted, it is possible to prevent the deformation of the bearing portion, and deterioration in slidability of the rack shaft.

In the steering apparatus, a plurality of the protruding portions may be circumferentially provided in the bearing member with a gap interposed between adjacent ones of the plurality of the protruding portions in the circumferential direction. With this configuration, compared to when the above-mentioned configuration is not adopted, it is possible to reduce a load exerted on the pressing member.

In the steering apparatus, a slit may be formed by cutting at least a portion of the bearing portion of the bearing member along the axial direction. With this configuration, for example, it is possible to prevent the deformation of the bearing portion even in high temperature conditions. Compared to when the above-mentioned configuration is not adopted, it is possible to prevent deterioration in slidability of the rack shaft.

According to another aspect of the present invention, provided is a steering apparatus including a pinion shaft that has a pinion; a rack shaft that has a rack which meshes with the pinion of the pinion shaft; a bearing member that has a supporting surface which supports the rack shaft in such a manner that the rack shaft is slidable in an axial direction of the rack shaft; an accommodating member that accommodates the bearing member; and an interposing member that is inserted into the accommodating member in the axial direction, and axially interposes the bearing member between the interposing member and the accommodating member at a position which deviates in a radial direction of the rack shaft and the axial direction with respect to the supporting surface.

According to still another aspect of the present invention, provided is a bearing member that is accommodated in an accommodating member, and supports a rack shaft having a rack which meshes with a pinion of a pinion shaft. The bearing member includes a bearing portion that supports the rack shaft in such a manner that the rack shaft is slidable in an axial direction of the rack shaft; and a protruding portion that protrudes from the bearing portion in a radial direction of the rack shaft and the axial direction, and is pressed against the accommodating member in the axial direction in a state that the bearing member is accommodated in the accommodating member.

According to the aspects of the present invention, it is possible to prevent the axial movement of the bearing member by which the rack shaft is supported in a state of being slidable in the axial direction.

### BRIEF DESCRIPTION OF THE DRAWINGS

FIG. 1 is a configuration view illustrating the entirety of a motor-driven power steering apparatus of an embodiment.

FIG. 2 is a configuration view of a transmission mechanism unit of the motor-driven power steering apparatus of the embodiment.

FIG. 3 is a configuration view of an assisting unit of the motor-driven power steering apparatus of the embodiment.

FIG. 4 is a schematic cross-sectional view describing the configuration of a rack supporting portion of the embodiment.

FIG. 5 is a schematic cross-sectional view describing the configuration of the rack supporting portion of the embodiment.

FIG. 6 is a schematic perspective view illustrating the configuration of a rack bush of the embodiment.

FIG. 7 is a cross-sectional view when portion VII in FIG. 6 is cut by a plane in parallel with axial and radial directions.

### DETAILED DESCRIPTION OF THE INVENTION

Hereinafter, an embodiment of the present invention will be described in detail with reference to the accompanying drawings. Entire Configuration of Motor-driven Power Steering Apparatus 1

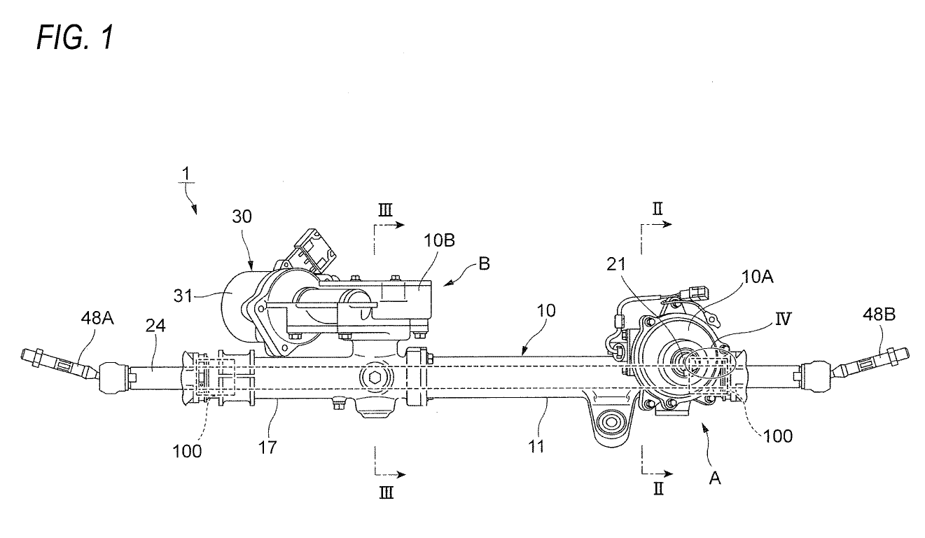

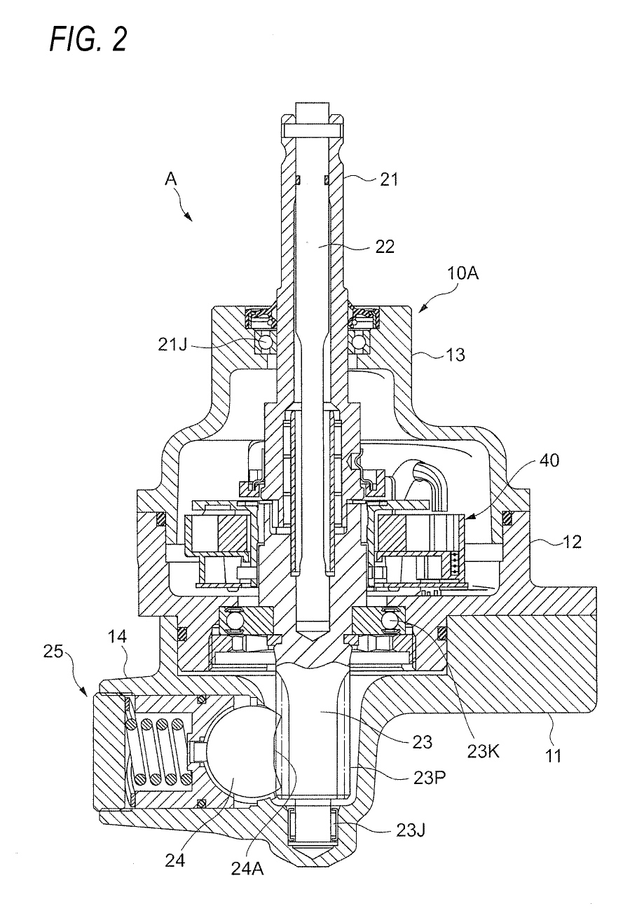

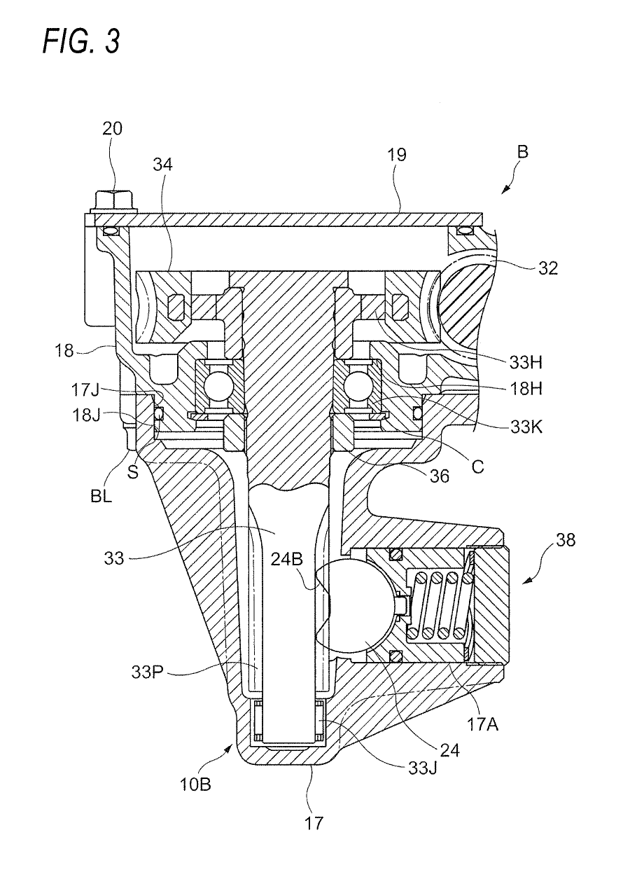

FIG. 1 is a configuration view illustrating the entirety of a motor-driven power steering apparatus 1 of the embodiment. FIG. 2 is a configuration view of a transmission mechanism unit A of the motor-driven power steering apparatus 1 of the embodiment, and a cross-sectional view taken along line II-II illustrated in FIG. 1. FIG. 3 is a configuration view of an assisting unit B of the motor-driven power steering apparatus 1 of the embodiment, and a cross-sectional view taken along line III-III illustrated in FIG. 1.

As illustrated in FIG. 1, the motor-driven power steering apparatus 1 of the embodiment is a so-called dual pinion power steering apparatus. The motor-driven power steering apparatus 1 has the transmission mechanism unit A that transmits a steering force from a steering unit (a steering wheel) to a rack shaft 24, and the assisting unit B that transmits a steering assistance force from a drive unit 30 to the rack shaft 24, thereby assisting the movement of the rack shaft 24.

For example, as illustrated in FIG. 1, a gear housing 10 fixed to a vehicle body frame (not illustrated) or the like has a steering wheel-side gear housing 10A that is a member of the transmission mechanism unit A, and an assist side gear housing 10B that is a member of the assisting unit B. The gear housing 10 is configured when the steering wheel-side gear housing 10A and the assist side gear housing 10B are connected together around the rack shaft 24.

The steering wheel-side gear housing 10A rotatably supports an input shaft 21 and a steering wheel-side pinion shaft 23 (refer to FIG. 2) that is an output shaft. The input shaft 21 is connected to an upper shaft (not illustrated) connected to a steering wheel (not illustrated).

In contrast, the assist side gear housing 10B rotatably supports an assist side pinion shaft 33 (refer to FIG. 3). Right and left tie rods 48A and 48B are respectively connected to opposite end portions of the rack shaft 24. The tie rods 48A and 48B are respectively connected to tires (not illustrated) which are steered units, via respective knuckle arms (not illustrated). The rack shaft 24 is supported by a rack supporting portion 100 which is provided in a first housing 11 (refer to FIG. 2) of the steering wheel-side gear housing 10A and a first housing 17 (refer to FIG. 3) of the assist side gear housing 10B, while maintaining good slidability in a crosswise direction in FIG. 1.

The detailed configuration of the rack supporting portion 100 will be described later. Configuration and Function of Transmission Mechanism Unit A

As illustrated in FIG. 2, the steering wheel-side gear housing 10A of the transmission mechanism unit A is divided into the first housing 11, a second housing 12, and a third housing 13. A housing is formed when the first housing 11, the second housing 12, and the third housing 13 are assembled together. The first housing 11, the second housing 12, and the third housing 13 are fixed together with fixing bolts (not illustrated).

As illustrated in FIG. 2, the transmission mechanism unit A has the input shaft 21 connected to the steering wheel (not illustrated). The transmission mechanism unit A has the steering wheel-side pinion shaft 23 (the output shaft) that is connected to the input shaft 21 via a torsion bar 22, and that is coaxial with the input shaft 21.

The steering wheel-side pinion shaft 23 has a pinion 23P, and the pinion 23P meshes with a steering wheel-side rack 24A of the rack shaft 24. Accordingly, the rack shaft 24 can linearly move as a steering torque is exerted on the steering wheel, and moves in the gear housing 10 in the crosswise direction illustrated in FIG. 1.

The input shaft 21 is held by a bearing 21J provided in the third housing 13 of the steering wheel-side gear housing 10A. The steering wheel-side pinion shaft 23 is held by a bearing 23J provided in the first housing 11 of the steering wheel-side gear housing 10A, and a bearing 23K provided in the second housing 12.

A rack guide 25 is provided in the first housing 11 of the steering wheel-side gear housing 10A so as to push the steering wheel-side rack 24A of the rack shaft 24 against the pinion 23P of the steering wheel-side pinion shaft 23, and to slidably support the rack shaft 24. The rack guide 25 is inserted into a cylinder portion 14 of the first housing 11.

The transmission mechanism unit A includes a torque detecting device 40 that detects a relative rotation angle between the input shaft 21 and the steering wheel-side pinion shaft (the output shaft) 23, and that detects a steering torque based on the detected relative rotation angle. The torque detecting device 40 sends the detected steering torque to an electronic control unit (ECU) which is not illustrated. The ECU controls the drive unit 30 (refer to FIG. 1) of the assisting unit B based on the detected steering torque acquired from the torque detecting device 40.

### Configuration and Function of Assisting Unit B

As illustrated in FIG. 3, the assisting unit B includes the assist side gear housing 10B; the assist side pinion shaft 33; a worm wheel 34 that is connected to the assist side pinion shaft 33; and the drive unit 30 (refer to Fig, 1) that drives the rotation of the worm wheel 34. The assisting unit B has a rack guide 38 that guides the movement of the rack shaft 24 connected to the assist side pinion shaft 33.

As illustrated in FIG. 3, the assist side gear housing 10B is divided into the first housing 17 and a second housing 18. A housing is formed when the first housing 17 and the second housing 18 are assembled together. A cover member 19 is assembled on the second housing 18. A cylindrical space is formed inside each of the first housing 17 and the second housing 18. The first housing 17 forms a housing mainly for a connection portion between the assist side pinion shaft 33 and the rack shaft 24. The second housing 18 forms a housing mainly for a connection portion between the assist side pinion shaft 33 and the worm wheel 34.

The first housing 17 has a fitting portion 17J through which the first housing 17 and the second housing 18 are fitted together. The second housing 18 has a fitting portion 18J through which the second housing 18 and the first housing 17 are fitted together. In the embodiment, the fitting portion 18J has an outer diameter slightly smaller than the inner diameter of the fitting portion 17J. The fitting portion 18J is inserted into the fitting portion 17J with a sealing member S interposed therebetween, and thus the first housing 17 and the second housing 18 are fitted together. The first housing 17 and the second housing 18 are fixed together with fixing bolts BL.

As illustrated in FIG. 3, the cover member 19 is fixed to the second housing 18 by using fixing bolts 20. The cover member 19 is provided to cover an opening portion of the first housing 17.

The assist side pinion shaft 33 mounted in the vehicle is disposed to intersect a vertical direction. In the embodiment, the assist side pinion shaft 33 is placed in a substantially horizontal direction so as to lie along a longitudinal direction of the vehicle (refer to FIG. 1).

As illustrated in FIG. 3, the assist side pinion shaft 33 has a pinion 33P. The pinion 33P of the assist side pinion shaft 33 is connected to an assist side rack 24B of the rack shaft 24. In the assisting unit B of the embodiment, both of or at least one of the pinion 33p of the assist side pinion shaft 33 and the assist side rack 24B of the rack shaft 24 is a helical gear, the tooth helix of which obliquely intersects its center axis. In the embodiment, the assist side pinion shaft 33 is made of metal.

The assist side pinion shaft 33 is provided with the worm wheel 34. The assist side pinion shaft 33 receives a rotation driving force from the drive unit 30 via the worm wheel 34 so as to rotate.

One end of the assist side pinion shaft 33 is held by a first bearing 33J provided in the first housing 17. The other end of the assist side pinion shaft 33 is held by a second bearing 33K provided in the second housing 18.

The inner ring of the second bearing 33K is attached onto the outer circumference of the assist side pinion shaft 33 with the inner ring interposed between a hub 33H and a lock nut 36 of the assist side pinion shaft 33. The outer ring of the second bearing 33K is fixed to the second housing 18 with the outer ring interposed between a holding portion 18H formed in the second housing 18 and a circlip C.

In contrast, the outer ring of the first bearing 33J is press fitted into the first housing 17, and one end portion of the assist side pinion shaft 33 is loosely fitted into the inner ring of the first bearing 33J.

Since the assist side pinion shaft 33 is held by the first bearing 33J that is press fitted into the first housing 17, the assist side pinion shaft 33 is limited to move toward the first housing 17.

The inner ring of the second bearing 33K is fixed to the assist side pinion shaft 33 by using the lock nut 36 with a built-in screw. The outer ring of the second bearing 33K is fixed to the holding portion 18H of the second housing 18 by using the circlip C. Accordingly, the assist side pinion shaft 33 is limited to move toward the second housing 18.

As such, the assist side pinion shaft 33 is attached to the assist side gear housing 10B in such a manner that the assist side pinion shaft 33 is rotatably held but does not move in an axial direction of the assist side pinion shaft 33.

The worm wheel 34 is provided in the one end portion of the assist side pinion shaft 33, which is opposite to the pinion 33P formed on the assist side pinion shaft 33. The rotation axis of the worm wheel 34 is coaxial with the axis of the assist side pinion shaft 33. As illustrated in FIG. 3, the worm wheel 34 meshes with a worm gear 32 of the drive unit 30. In the embodiment, the worm wheel 34 is made of resin, and is formed integrally with the hub 33H of the metal assist side pinion shaft 33.

The rack guide 38 is attached into the first housing 17 of the assist side gear housing 10B so as to push the assist side rack 24B of the rack shaft 24 against the pinion 33P of the assist side pinion shaft 33, and to slidably support the rack shaft 24. The rack guide 38 is inserted into a cylinder portion 17A of the first housing 17.

As illustrated in FIG. 1, the drive unit 30 has an electric motor 31, and the worm gear 32 (refer to FIG. 3) that is driven to rotate by the electric motor 31. The ECU (not illustrated) controls the drive of the electric motor 31 based on the detection results from the torque detecting device 40 (refer to FIG. 2). As illustrated in FIG. 3, the worm gear 32 is connected to the worm wheel 34, and transmits an output torque from the electric motor 31 to the worm wheel 34.

Subsequently, the configuration of the rack supporting portion 100 of the embodiment will be described. In the motor-driven power steering apparatus 1 of the embodiment, as illustrated in FIG. 1, the rack supporting portion 100 is provided in both the first housing 17 of the assist side gear housing 10B and the first housing 11 of the steering wheel-side gear housing 10A. The rack supporting portion 100 supports the opposite end portions of the rack shaft 24. Hereinafter, the rack supporting portion 100 provided in the first housing 11 of the steering wheel-side gear housing 10A will be described as an example. Configuration of Rack Supporting Portion 100

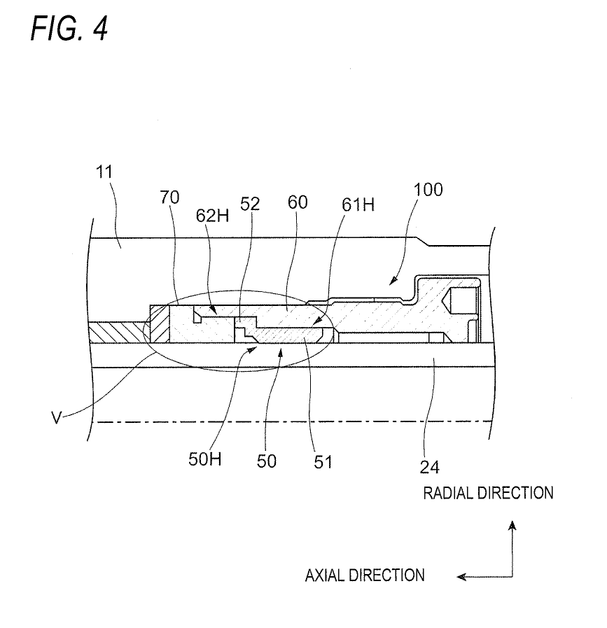

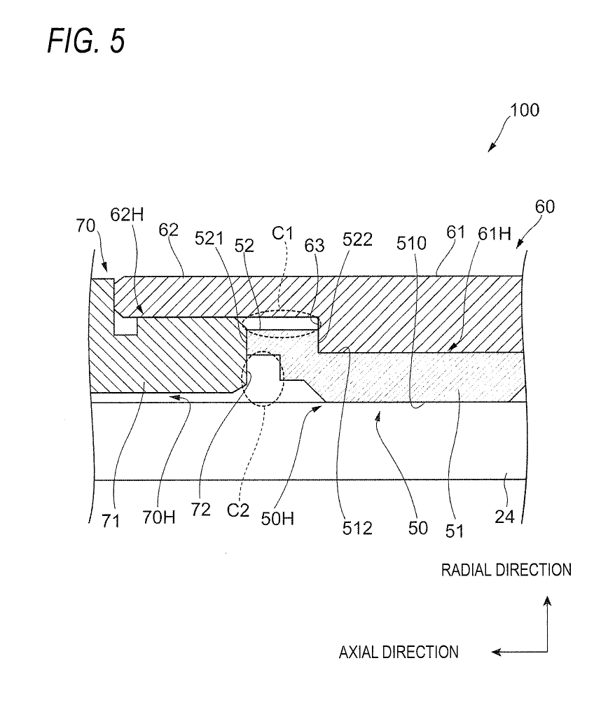

FIGS. 4 and 5 are schematic cross-sectional views describing the configuration of the rack supporting portion 100 of the embodiment. FIG. 4 is a cross-sectional view when the periphery of the rack supporting portion 100 of the motor-driven power steering apparatus 1 is cut along the axial direction of the rack shaft 24, and corresponds to a cross-sectional view of portion IV illustrated in FIG. 1. FIG. 5 is an enlarged view of portion V illustrated in FIG. 4.

In the embodiment, the rack supporting portion 100 has a cylindrical shape in its entirety. A columnar hole is formed in the rack supporting portion 100 so as to extend along the axial direction. As illustrated in FIGS. 4 and 5, the rack supporting portion 100 is inserted into the first housing 11 of the steering wheel-side gear housing 10A (the first housing 17 of the assist side gear housing 10B; refer to FIG. 1), and the rack shaft 24 is inserted into the hole formed inside the rack supporting portion 100.

In the embodiment, the rack shaft 24 is supported by the rack supporting portion 100. Accordingly, the rack shaft 24 is prevented from striking against the first housing 11 (the first housing 17), and thus friction from the rack shaft 24 is prevented.

As illustrated in FIGS. 4 and 5, the rack supporting portion 100 of the embodiment includes a rack bush 50 that is an example of a bearing member including a bearing portion by which the rack shaft 24 is supported in a state of being slidable in the axial direction; an end case 60 that is an example of an accommodating member accommodating the rack bush 50; a stopper 70 that is an example of a pressing member inserted into the end case 60 and pressing the rack bush 50 against the end case 60, or an example of an interposing member.

Detailed description will be given later, but in the rack supporting portion 100 of the embodiment, the rack bush 50 has protruding portions 52, each of which protrudes at a position that is deviated from a bearing surface 510 in a radial direction and the axial direction of the rack shaft 24, the bearing surface 510 rotatably supporting the rack shaft 24. Since the protruding portion 52 is interposed between the end case 60 and the stopper 70, the axial movement of the rack bush 50 is regulated.

Upon the description of the structure of each of the rack supporting portion 100, the rack bush 50, the end case 60, the stopper 70, and the like, in a state where the rack supporting portion 100 supports the rack shaft 24, an “axial direction” refers to the axial direction of the rack shaft 24, a “radial direction” refers to a direction which extends from the axis to the outer circumference of the rack shaft 24, and a “circumferential direction” refers to an outer circumferential direction of the rack shaft 24.

### Configuration of Rack Bush 50

Subsequently, the configuration of the rack bush 50 of the embodiment will be described.

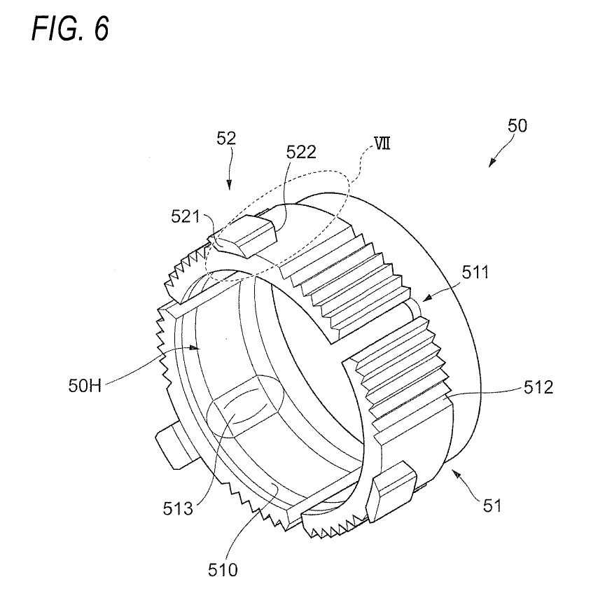

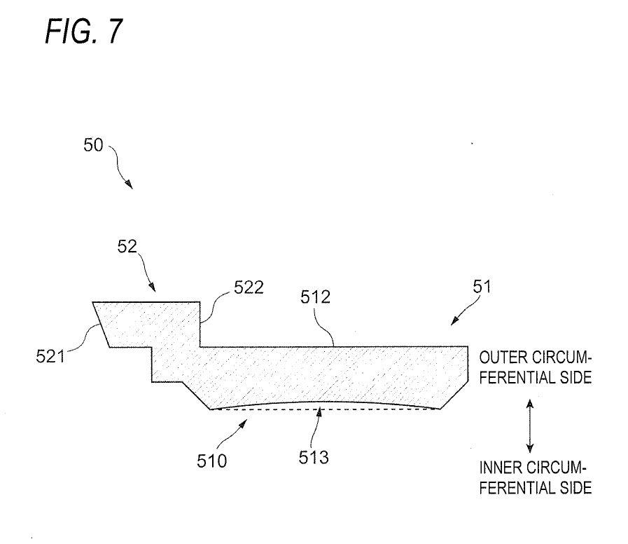

FIG. 6 is a schematic perspective view illustrating the configuration of the rack bush 50 of the embodiment. FIG. 7 is a cross-sectional view when portion VII in FIG. 6 is cut by a plane in parallel with the axial and radial directions. Here, FIGS. 6 and 7 illustrate the rack bush 50 that is not interposed between the end case 60 and the stopper 70.

In the embodiment, the rack bush 50 is made of a resin material such as polyacetal resin, thermoplastic elastomer, or polyamide resin, and typically, is used with oil impregnated therein.

Detailed description will be given later, but since the rack bush 50 is made of a resin material, the rack bush 50 has a coefficient of thermal expansion (a coefficient of linear expansion) greater than that of the end case 60 (refer to FIG. 4) made of metal or the like. Since the rack bush 50 has rigidity lower than that of each of the end case 60 and the stopper 70 (refer to FIG. 4), the rack bush 50 is deformable when being interposed between the end case 60 and the stopper 70.

In the embodiment, since the rack bush 50 is made of a resin material, the rack bush 50 can absorb the end play (micro-vibration) of the rack shaft 24 (refer to FIG. 4). Compared to when the rack bush 50 is not made of a resin material, the collision of the rack bush 50 and the rack shaft 24 is further prevented from causing noise to occur.

As illustrated in FIG. 6, the rack bush 50 of the embodiment includes the bearing portion 51 which has a cylindrical shape in its entirety, and the inner circumference that is provided with a columnar rack shaft hole 50H into which the rack shaft 24 is inserted; and the protruding portions 52, each of which is provided on an outer circumferential side of the bearing portion 51 so as to protrude from the bearing portion 51 in the axial and radial directions.

### Regarding Configuration of Bearing Portion 51

The bearing portion 51 has the bearing surface 510 which forms the rack shaft hole 50H and supports the outer circumference of the rack shaft 24 inserted into the rack shaft hole 50H in such a manner that the rack shaft 24 is slidable in the axial direction; and a contact surface 512 that is provided on the outer circumferential side of the bearing portion 51 so as to face the bearing surface 510, and that is in contact with an inner circumferential surface of a bush insertion hole 61H (refer to FIG. 5) of the end case 60, thereby preventing fluctuation in the bearing surface 510.

Slits 511 are formed in the bearing portion 51 along the axial direction, and the slit 511 is formed by portions of the bearing surface 510 and the contact surface 512 being cut from axially one end along the axial direction.

In the embodiment, as illustrated in FIG. 6, three slits 511 are respectively provided in the bearing portion 51 so as to separate equally from each other in the circumferential direction. The slits 511 are provided in the bearing portion 51, while being separate from each other by 120°.

As illustrated in FIGS. 6 and 7, thin wall portions 513 are provided in the bearing portion 51 so as to correspond to respective positions in which the protruding portions 52 are provided, and the thin wall portions 513 are formed when a portion of the bearing surface 510 is cut out in a thickness direction of the rack bush 50.

In the rack bush 50 of the embodiment, the rack shaft hole 50H has an inner diameter (the inner diameter of the bearing surface 510) slightly greater than the outer diameter of the rack shaft 24. Accordingly, the rack shaft 24 can be supported by the bearing portion 51 in such a manner that the rack shaft 24 is slidable in the axial direction in the rack shaft hole 50H formed by the bearing surface 510.

### Configuration of Protruding Portion 52

In the rack bush 50 of the embodiment, the protruding portions 52 are respectively provided on axially one end of the bearing portion 51 at three locations that are separate equally from each other in the circumferential direction. In other words, a gap is formed in the circumferential direction between the adjacent protruding portions 52. Specifically, the protruding portions 52 are provided, while being separate from each other by 120°.

As illustrated in FIGS. 5 and 6, each of the protruding portions 52 is provided on an outer circumferential side of the bearing surface 510 of the bearing portion 51 in the axial direction. Each of the protruding portions 52 is provided so as to axially deviate to the one end (to the left in FIG. 5) with respect to the bearing surface 510 of the bearing portion 51.

When the protruding portions 52 are assembled in the rack supporting portion 100, each of the protruding portions 52 has a stopper pressing surface 521 against which a bush pressing surface 72 (to be described later) of the stopper 70 is pressed, and an end case pressing surface 522 which is provided so as to face the stopper pressing surface 521, and against which a bush supporting surface 63 (to be described later) of the end case 60 is pressed when the stopper pressing surfaces 521 are pressed by the stopper 70.

In the embodiment, as illustrated in FIG. 7, before the rack bush 50 is deformed, the stopper pressing surface 521 is inclined so as to be separate from the bearing portion 51 from the radially inner circumference to the radially outer circumference of the stopper pressing surface 521. In other words, the axial length of the protruding portion 52 between the end case pressing surface 522 and the stopper pressing surface 521 increases from the inner circumference to the outer circumference of the protruding portion 52.

As illustrated in FIG. 5 and the like, in the rack bush 50 of the embodiment, the end case pressing surface 522 is provided at a position that deviates in the axial direction (the left in FIG. 5) with respect to the bearing surface 510 of the bearing portion 51.

### Configuration of End Case 60

In the end case 60 assembled in the rack supporting portion 100, the end case 60 is a member which accommodates and supports the rack bush 50, and into which the stopper 70 is press fitted.

As illustrated in FIG. 5, the end case 60 of the embodiment includes a bush insertion portion 61 that is provided with the bush insertion hole 61H into which the bearing portion 51 of the rack bush 50 is inserted, and a stopper insertion portion 62 that is provided to be axially adjacent to the bush insertion portion 61, and that is provided with a stopper insertion hole 62H into which the stopper 70 is inserted (press fitted).

Here, in the embodiment, the stopper insertion hole 62H has an inner diameter greater than the inner diameter of the bush insertion hole 61H. In the embodiment, when the end case 60 and the rack bush 50 are seen in the axial direction, the stopper insertion hole 62H has a radius (a length between the axial center of the end case 60 and an inner circumferential surface of the stopper insertion hole 62H) greater than a length between the axial center of the rack bush 50 and an outer circumferential portion of the protruding portion 52.

In the end case 60 of the embodiment, a bush supporting surface 63 is formed between the bush insertion portion 61 and the stopper insertion portion 62, and the respective end case pressing surfaces 522 of the protruding portions 52 of the rack bush 50 are pushed against the bush supporting surface 63. The bush supporting surface 63 is a surface extending in a direction vertical to the axial direction and the radial direction. In the embodiment, the bush supporting surface 63 is provided on the entirety of the end case 60 in the circumferential direction.

### Configuration of Stopper 70

When the stopper 70 is assembled in the rack supporting portion 100, the stopper 70 is inserted into the stopper insertion portion 62 (the stopper insertion hole 62H) of the end case 60, and pushes the protruding portions 52 of the rack bush 50 against the end case 60.

In the embodiment, as illustrated in FIG. 5, a rack insertion hole 70H is formed in the stopper 70, and the rack shaft 24 extending in the axial direction is inserted into the rack insertion hole 70H. The stopper 70 has an inserted portion 71 that is inserted into the stopper insertion portion 62 (the stopper insertion hole 62H) of the end case 60. The inserted portion 71 has a cylindrical shape. The bush pressing surface 72 is formed at the tip of the inserted portion 71, and is pressed against the respective stopper pressing surfaces 521 of the protruding portions 52.

In the stopper 70 of the embodiment, the inserted portion 71 has an outer diameter slightly greater than the inner diameter of the stopper insertion hole 62H of the end case 60. Detailed description will be given later, but since there is such a relationship between the outer diameter of the inserted portion 71 and the inner diameter of the stopper insertion hole 62H, the inserted portion 71 is press fitted into the stopper insertion hole 62H when the rack supporting portion 100 is assembled. Accordingly, the axial position of the stopper 70 is fixed in the rack supporting portion 100.

### Problem of Rack Supporting Portion in Related Art

The related art discloses a rack supporting portion including the rack bush that slidably supports the rack shaft, and an end case provided with a groove portion for the accommodation of the rack bush. In the rack supporting portion of the related art, for example, the rack bush may axially move in the groove portion in association with the sliding of the rack shaft. When the rack bush moves, the rack bush may collide with a groove wall of the end case, thereby causing noise to occur.

As a countermeasure against an occurrence of noise, for example, the stopper is provided to regulate the axial movement of the rack bush, and the rack bush is axially interposed between the end case and the stopper, thereby preventing the movement of the rack bush. More specifically, the bearing portion of the rack bush is interposed between the end case and the stopper, and is provided with the bearing surface that slidably supports the rack shaft. Accordingly, the axial movement of the rack bush is prevented, and noise is prevented from occurring.

Here, as described above, for example, the rack bush is made of a resin material having rigidity lower than that of the metal end case, so as to absorb the end play (micro-vibration) of the rack shaft. Accordingly, when the bearing portion of the rack bush is interposed between the end case and the stopper so as to regulate the axial movement of the rack bush, the bearing portion may be deformed. Specifically, since the end case and the stopper press the bearing portion in the axial direction, the bearing portion may be bent in the radial direction. When the bearing portion is bent in the radial direction, the bearing surface, which slidably supports the rack shaft, projects toward the inner circumference (the axial center of the rack shaft) of the bearing portion, and thus the slidability of the rack shaft may deteriorate.

Since the rack bush made of a resin material has a coefficient of thermal expansion (a coefficient of linear expansion) greater than that of the end case, for example, the rack bush contracts in low temperature conditions, and thus the rack bush may move from the end case or the like, or may slip out of its normal position.

For example, since the rack bush undergoes thermal expansion in high temperature conditions, the bearing surface supporting the rack shaft projects toward the inner circumference, and thus the slidability of the rack shaft may deteriorate.

In contrast, in the rack supporting portion 100 of the embodiment, the rack bush 50 is provided with the protruding portions 52, the protruding portions 52 are interposed between the end case 60 and the stopper 70, and the rack bush 50 is supported. Accordingly, the above-mentioned problem is solved.

### Detailed Structure of Rack Supporting Portion 100

Subsequently, the following will be described in more detail: the respective structures of the rack bush 50, the end case 60, and the stopper 70 of the rack supporting portion 100, and the action of the rack supporting portion 100 of the embodiment.

In the embodiment, the rack supporting portion 100 is assembled when the rack bush 50 is inserted into the bush insertion hole 61H of the end case 60 in the axial direction (from the left to the right in FIG. 4), and then the inserted portion 71 of the stopper 70 is axially press fitted into the stopper insertion hole 62H of the end case 60 into which the rack bush 50 is inserted (from the left to the right in FIG. 4).

As illustrated in FIGS. 4 and 5, in the rack supporting portion 100 of the embodiment, the stopper 70 is press fitted into the end case 60, and thus the bush pressing surface 72 of the stopper 70 is axially pressed against the respective stopper pressing surfaces 521 of the protruding portions 52 of the rack bush 50. The respective end case pressing surfaces 522 of the protruding portions 52 are pressed against the bush supporting surface 63 of the end case 60.

As a result, in the rack supporting portion 100, the protruding portions 52 of the rack bush 50 are interposed between the bush pressing surface 72 of the stopper 70 and the bush supporting surface 63 of the end case 60.

Concerning the bearing portion 51 of the rack bush 50 of the rack supporting portion 100, opposite ends of the bearing portion 51 in the axial direction are not respectively in contact with the stopper 70 and the end case 60, and the bearing portion 51 is interposed between the stopper 70 and the end case 60.

In other words, in the rack supporting portion 100 of the embodiment, regional portions (the protruding portions 52) of the rack bush 50 in the axial direction are supported by the stopper 70 and the end case 60.

Here, as described above, the rack bush 50 of the embodiment is made of a resin material that has rigidity lower than that of each of the end case 60 and the stopper 70. Accordingly, in the rack supporting portion 100, the protruding portions 52 are interposed between the bush pressing surface 72 of the stopper 70 and the bush supporting surface 63 of the end case 60 in a state that the protruding portions 52 are crushed and deformed. In the rack supporting portion 100 of the embodiment, the protruding portions 52 are fixed between the bush pressing surface 72 of the stopper 70 and the bush supporting surface 63 of the end case 60 due to the respective elastic forces of the deformed protruding portions 52.

Accordingly, in the rack supporting portion 100, the axial movement of the rack bush 50 is regulated. The rack bush 50 is prevented from moving in the axial direction, and colliding with the end case 60 and the like. As a result, noise resulting from a collision between the rack bush 50 and the end case 60 is prevented from occurring.

In the embodiment, the press-fit length of the stopper 70 (the inserted portion 71) with respect to the stopper insertion hole 62H of the end case 60 is preferably set as follows.

That is, the press-fit length of the stopper 70 is preferably set such that the rack bush 50 (the protruding portions 52) pressed by the stopper 70 exerts stress on the end case 60 (the bush supporting surface 63) to the extent not exceeding an allowable stress of the end case 60. The press-fit length of the stopper 70 is preferably set so that the stopper 70 does not slip out of the end case 60 due to the respective elastic forces of the protruding portions 52 which are interposed between the stopper 70 and the end case 60 and thus are deformed.

The press-fit length of the stopper 70 is preferably set so that the sliding resistance of the rack shaft 24 or the contraction of the rack bush 50 in low temperature conditions does not cause a space to occur between the stopper 70 and the rack bush 50 or the end play (micro-vibration) of the rack bush 50.

For example, the assembled rack supporting portion 100 is inserted into the first housing 11 of the steering wheel-side gear housing 10A in the axial direction (from the right to the left in FIG. 4), and thus the rack supporting portion 100 is attached to the motor-driven power steering apparatus 1.

Here, as described above, in the rack bush 50 of the embodiment, the protruding portion 52 is provided at the position that radially deviates to the outer circumference with respect to the bearing portion 51 (the bearing surface 510).

Accordingly, even when the stopper 70 is inserted into the end case 60 in the axial direction, and the protruding portions 52 are interposed between the stopper 70 and the end case 60, thereby exerting an axial force on each of the protruding portions 52, an axial force is prevented from being directly exerted on the bearing portion 51.

As described above, in the rack bush 50 of the embodiment, the protruding portions 52 are provided at the position that axially deviates to the one end with respect to the bearing portion 51 (the bearing surface 510).

Accordingly, even when the protruding portions 52 are interposed between the stopper 70 and the end case 60, and thus the protruding portions 52 are bent in the radial direction, the radial deformation of the protruding portion 52 is prevented from affecting the bearing portion 51.

As such, in the rack bush 50 of the rack supporting portion 100 of the embodiment, the protruding portions 52 are interposed between the stopper 70 and the end case 60, while being provided at a position that deviates from the bearing surface 510 in the axial and radial directions. Accordingly, compared to when the above-mentioned configuration is not adopted, the deformation of the protruding portion 52 is further prevented from affecting the bearing portion 51. As a result, in the embodiment, the bearing surface 510 of the bearing portion 51 is prevented from being bent in the radial direction. Compared to when the above-mentioned configuration is not adopted, the slidability of the rack shaft 24 supported by the bearing surface 510 is further prevented from deteriorating.

In the rack supporting portion 100 of the embodiment, as described above, the stopper insertion hole 62H of the end case 60 has a radius greater than a radial length between the axial center of the rack bush 50 and the outer circumferential portion of the protruding portion 52. Accordingly, in the rack supporting portion 100, as illustrated in FIG. 5, a space CI is formed between an outer circumferential surface of the protruding portion 52 and the inner circumferential surface of the stopper insertion hole 62H.

In the rack bush 50 of the rack supporting portion 100 of the embodiment, as illustrated in FIG. 5, the protruding portions 52 are formed in a state of deviating with respect to the bearing portion 51 in the axial and radial directions. Accordingly, a space C2 is formed on an inner circumferential side of the protruding portion 52.

In other words, in the rack supporting portion 100 of the embodiment, the spaces (the space C1 and the space C2) are formed on an outer circumferential side and the inner circumferential side of the protruding portion 52 in the radial direction, while being adjacent to each other.

Accordingly, in the rack supporting portion 100, when the protruding portions 52 are axially interposed between the stopper 70 and the end case 60, the protruding portions 52 are deformable in the radial direction in such a manner that the protruding portion 52 protrudes toward the space C 1 or the space C2. As a result, the crushing and deformation of the protruding portion 52 is prevented from affecting the bearing portion 51, and the slidability of the rack shaft 24 supported by the bearing surface 510 is prevented from deteriorating.

As described above, in the protruding portions 52 of the embodiment, the stopper pressing surface 521 is inclined so as to be separate from the bearing portion 51 from the radially inner circumference to the radially outer circumference of the stopper pressing surface 521. In other words, the stopper pressing surface 521 is inclined so as to protrude toward the stopper 70 from the radially inner circumference to the radially outer circumference of the stopper pressing surface 521. Accordingly, in the embodiment, the axial length of the protruding portion 52 increases from the inner circumference to the outer circumference of the protruding portion 52.

Since the protruding portion 52 has the above-mentioned shape, when the protruding portions 52 in the rack supporting portion 100 are interposed between the stopper 70 and the end case 60, the protruding portion 52 is likely to be bent toward the space C1 formed on the outer circumferential side of the protruding portion 52. As a result, in the rack supporting portion 100 of the embodiment, compared to when the above-mentioned configuration is not adopted, the crushing and deformation of the protruding portion 52 is further prevented from affecting the bearing portion 51.

In the example illustrated in FIG. 7, the stopper pressing surface 521 of the protruding portion 52 has an inclined shape. Insofar as the axial length of the protruding portion 52 increases from the inner circumference to the outer circumference, for example, the end ease pressing surface 522 may be inclined from the inner circumference to the outer circumference.

As described above, the plurality of (three) protruding portions 52 are circumferentially provided in the rack bush 50. The gap is formed in the circumferential direction between the adjacent protruding portions 52. Accordingly, in the rack supporting portion 100 of the embodiment, the stopper 70 and the end case 60 support the rack bush 50 with the regional portions of the rack bush 50 interposed between the stopper 70 and the end case 60 in the circumferential direction.

Since the rack supporting portion 100 adopts the above-mentioned configuration, the stopper 70 and the end case 60 can deform the protruding portions 52 with a reduced pressure, for example, compared to when the protruding portion 52 is continuously provided in the entirety of the rack bush in the circumferential direction, and the entirety of the protruding portion 52 in the circumferential direction is interposed between the stopper 70 and the end case 60. In addition, when the stopper 70 is press fitted into the end case 60, it is possible to reduce a load that the deformed protruding portions 52 exert on the stopper 70, and the stopper 70 is prevented from slipping out of the end case 60.

In the rack supporting portion 100 of the embodiment, as illustrated in FIGS. 4 and 5, the contact surface 512 of the rack bush 50 is in contact with the inner circumferential surface of the bush insertion hole 61H of the end case 60. Accordingly, the radial movement of the bearing portion 51 of the rack bush 50 is prevented. Compared to when the above-mentioned configuration is not adopted, the rack shaft 24 can be stably supported by the bearing surface 510 of the bearing portion 51.

In the rack bush 50 of the embodiment, as described above, the thin wall portions 513 (refer to FIG. 6) are formed in the bearing surface 510 so as to correspond to the respective positions in which the protruding portions 52 are provided. Accordingly, for example, even when the bearing portion 51 is deformed in association with the deformation of the protruding portions 52, the bearing surface 510 of the bearing portion 51 is prevented from protruding toward the rack shaft hole 50H. As a result, compared to when the above-mentioned configuration is not adopted, the rack shaft 24 is prevented from interfering with the bearing surface 510 of the rack bush 50, and the slidability of the rack shaft 24 is prevented from deteriorating.

Here, since the rack bush 50 is made of a resin material as described above, typically, the rack bush 50 has a coefficient of thermal expansion (a coefficient of linear expansion) greater than that of the end case 60 and the like. Accordingly, the rack bush 50 is likely to contract in low temperature conditions compared to the end case 60 and the like. The rack bush 50 is likely to expand in high temperature conditions compared to the end case 60 and the like.

In a state where the rack supporting portion 100 of the embodiment is assembled, as described above, the protruding portions 52 of the rack bush 50 are pressed and crushed by the stopper 70 and the end case 60. In other words, in the rack supporting portion 100, a preload occurs between the stopper 70 and the protruding portions 52 of the rack bush 50, and between the end case 60 and the protruding portions 52.

Accordingly, for example, when the rack bush 50 contracts in low temperature conditions, a gap is prevented from occurring between the stopper 70 and the protruding portions 52 of the rack bush 50, and between the end case 60 and the protruding portions 52 as much as is possible. Accordingly, in low temperature conditions, the end play (micro-vibration) of the rack bush 50 is prevented from occurring, and thus noise is prevented from occurring. The rack bush 50 is prevented from slipping out of its normal position.

As described above, in the rack bush 50 of the embodiment, each of the protruding portions 52 interposed between the stopper 70 and the end case 60 is provided at the position that deviates in the axial and radial directions with respect to the bearing surface 510 of the bearing portion 51.

Accordingly, for example, even when the rack bush 50 expands thermally in high temperature conditions, and the protruding portions 52 are deformed in the axial direction or the radial direction, the deformation of each of the protruding portions 52 is unlikely to affect the bearing portion 51. Compared to when the above-mentioned configuration is not adopted, the bearing portion 51 is unlikely to be deformed.

As described above, in the rack bush 50 of the embodiment, the slits 511 are provided in the bearing portion 51, and the slits 511 divide the bearing surface 510 into a plurality of surfaces.

For example, when the rack bush 50 expands thermally in high temperature conditions, the bearing portion 51 is deformed in the circumferential direction in such a manner that the slits 511 are closed. Accordingly, the radial deformation of the bearing portion 51 is prevented, and the bearing surface 510 is prevented from projecting to the inner circumference of the bearing portion 51.

As such, in the embodiment, even when the rack bush 50 is deformed in high temperature conditions due to thermal expansion, the slidability of the rack shaft 24 is prevented from deteriorating.

In the embodiment, the rack bush 50 includes the three protruding portions 52 that are provided on the one end of the bearing portion 51 in the axial direction so as to separate from each other at equal intervals in the circumferential direction. However, insofar as the protruding portions 52 are interposed between the stopper 70 and the end case 60 at the respective positions that deviate in the axial and radial directions with respect to the bearing surface 510 of the bearing portion 51, the shape and the position of the protruding portion 52, and the number of the protruding portions 52 are not particularly limited to those in the embodiment.

In the embodiment described above, the rack shaft 24 and the rack supporting portion 100 are applied to a dual pinion motor-driven power steering apparatus, but for example, may be applied to other motor-driven power steering apparatuses such as a rack assistance motor-driven power steering apparatus. The rack shaft 24 and the rack supporting portion 100 may be applied to a hydraulic power steering apparatus, or a manual steering apparatus that does not provide an assisting force.

What is claimed is:

1. A steering apparatus comprising:
a pinion shaft that has a pinion;
a rack shaft that has a rack which meshes with the pinion of the pinion shaft;
a bearing member that has a bearing portion which supports the rack shaft in such a manner that the rack shaft is slidable in an axial direction of the rack shaft, and a protruding portion which protrudes from the bearing portion in a radial direction of the rack shaft and the axial direction;
an accommodating member that accommodates the bearing member; and
a pressing member that is inserted into the accommodating member in the axial direction, and axially presses the protruding portion of the bearing member against the accommodating member.

2. The steering apparatus according to claim 1,
wherein the bearing member is made of a resin material, and
the protruding portion is interposed between the pressing member and the accommodating member in a state that the protruding portion is deformed.

3. The steering apparatus according to claim 1,
wherein an axial length of the protruding portion of the bearing member increases from a radially inner circumference of the protruding portion to a radially outer circumference thereof.

4. The steering apparatus according to claim 1,
wherein a plurality of the protruding portions are circumferentially provided in the bearing member with a gap interposed between adjacent ones of the plurality of the protruding portions in the circumferential direction.

5. The steering apparatus according to claim 1,
wherein a slit is formed by cutting at least a portion of the bearing portion of the bearing member along the axial direction.

6. A steering apparatus comprising:
a pinion shaft that has a pinion;
a rack shaft that has a rack which meshes with the pinion of the pinion shaft;
a bearing member that has a supporting surface which supports the rack shaft in such a manner that the rack shaft is slidable in an axial direction of the rack shaft;
an accommodating member that accommodates the bearing member; and
an interposing member that is inserted into the accommodating member in the axial direction, and axially interposes the bearing member between the interposing member and the accommodating member at a position which deviates in a radial direction of the rack shaft and the axial direction with respect to the supporting surface.

7. A bearing member that is accommodated in an accommodating member, and supports a rack shaft having a rack which meshes with a pinion of a pinion shaft, the bearing member comprising:
a bearing portion that supports the rack shaft in such a manner that the rack shaft is slidable in an axial direction of the rack shaft; and
a protruding portion that protrudes from the bearing portion in a radial direction of the rack shaft and the axial direction, and is pressed against the accommodating member in the axial direction in a state that the bearing member is accommodated in the accommodating member.
